(19) United States
(12) Patent Application Publication
(10) Pub. No.: US 2008/0292219 A1
(43) Pub. Date: Nov. 27, 2008

(54) Method And System For An Image Sensor Pipeline On A Mobile Imaging Device

(76) Inventors: Gary Keall, Long Clawson (GB); David Plowman, Great Chesterford (GB)

Correspondence Address: MCANDREWS HELD & MALLOY, LTD, 500 WEST MADISON STREET, SUITE 3400, CHICAGO, IL, 60661, US

(21) Appl. No.: 11/939,956

(22) Filed: Nov. 14, 2007

Related U.S. Application Data
(60) Provisional application No. 60/939,910, filed on May 24, 2007.

(51) Int. Cl. G06K 9/22

(52) U.S. Cl. 382/313

(57) ABSTRACT

In an embodiment of the invention, images are processed within a mobile device. Image data may be divided into variable size tiles and processed in steps or stages on a per tile basis within a hardware image sensor pipeline. The processing steps or stages may comprise one or more distortion correction steps. A portion of the variable size tiles may be processed via software within a processor. In this regard, output from any portion of the ISP may be stored in RAM and subsequently retrieved for software processing. The results from software processing may be stored in RAM and communicated back to any point within the hardware ISP for additional processing. The hardware ISP and the processor via software may simultaneously process different portions of the variable size tiles.

### CROSS-REFERENCE TO RELATED APPLICATIONS/INCORPORATION BY REFERENCE

This application makes reference to, claims priority to, and claims the benefit of U.S. Provisional Application Ser. No. 60/939,910 (Attorney Docket No. 18636US01), filed on May 24, 2007, which is hereby incorporated herein by reference in its entirety.

### FIELD OF THE INVENTION

Certain embodiments of the invention relate to processing of images. More specifically, certain embodiments of the invention relate to a method and system for an image sensor pipeline on a mobile imaging device.

### BACKGROUND OF THE INVENTION

For many people, mobile or hand held electronic devices have become a part of everyday life. Mobile devices have evolved from a convenient method for voice communication to multi functional resources that offer for example camera features, media playback, electronic gaming, internet browsing, email and office assistance.

Cellular phones with built-in cameras, or camera phones, have become prevalent in the mobile phone market, due to the low cost of CMOS image sensors and the ever increasing customer demand for more advanced cellular phones.

Historically, the resolution of camera phones has been limited in comparison to typical digital cameras. In this regard, they must be integrated into the small package of a cellular handset, limiting both the image sensor and lens size. In addition, because of the stringent power requirements of cellular handsets, large image sensors with advanced processing have been difficult to incorporate. However, due to advancements in image sensors, multimedia processors, and lens technology, the resolution of camera phones has steadily improved rivaling that of many digital cameras.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A method and system for an image sensor pipeline on a mobile imaging device, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary mobile multimedia system, in accordance with an embodiment of the invention.

FIG. 1B is a block diagram of an exemplary mobile multimedia processor, in accordance with an embodiment of the invention.

FIG. 2A is a block diagram of an exemplary mobile device configured to perform a plurality of image processing tasks comprising distortion correction, in accordance with an embodiment of the invention.

FIG. 2B is a block diagram of an exemplary image processing system comprising a portion of an image sensor pipeline (ISP) configured for distortion correction processing, in accordance with an embodiment of the invention.

FIG. 3 is a flow chart illustrating exemplary steps for an image sensor pipeline on a mobile imaging device enabled for distortion correction, in accordance with an embodiment of the invention.

### DETAILED DESCRIPTION OF THE INVENTION

Certain aspects of the invention may be found in a method and system for an image sensor pipeline on a mobile imaging device. In this regard, a processor may direct mega pixel images from an image source to an image sensor pipeline (ISP). The ISP may comprise a plurality of hardware stages that may enable processing techniques comprising dark pixel compensation, lens shading correction, white balance and gain control, defective pixel correction, resampling, crosstalk correction, bayer denoising, demosaicing, gamma correction, YCbCr denoising, false color suppression, sharpening, distortion correction, high resolution resize, color processing, color conversion, low resolution resize and output formatting, for example. Image data processed via the image sensor may be processed in tiled format. In this regard, received raw image data may be divided into a plurality of variable size tiles. The variable size tiles may be sequentially processed wherein processing may begin after one or more of the plurality of tiles is received. Each of the variable size tiles may comprise a plurality of lines. The size of a tile may be determined based on distortion in a corresponding region of the raw image data. For example, optical distortion from a camera lens may cause such regional distortion.

In some embodiments of the invention, a plurality of software processes may be inserted into the ISP hardware pipeline. In other words, data may be tapped or removed from any stage of the image sensor hardware pipeline and sent to a software process for processing. The resulting software processed data may then be reinserted at any stage of the image sensor hardware pipeline for processing. Data may be tapped from the ISP hardware pipeline, communicated to a software process, and reinserted back into any point of the image sensor hardware pipeline as many times as may be necessary for processing.

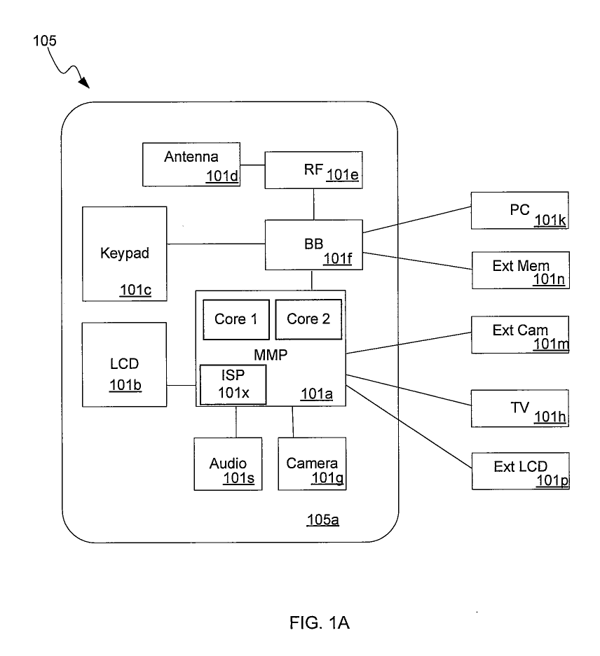

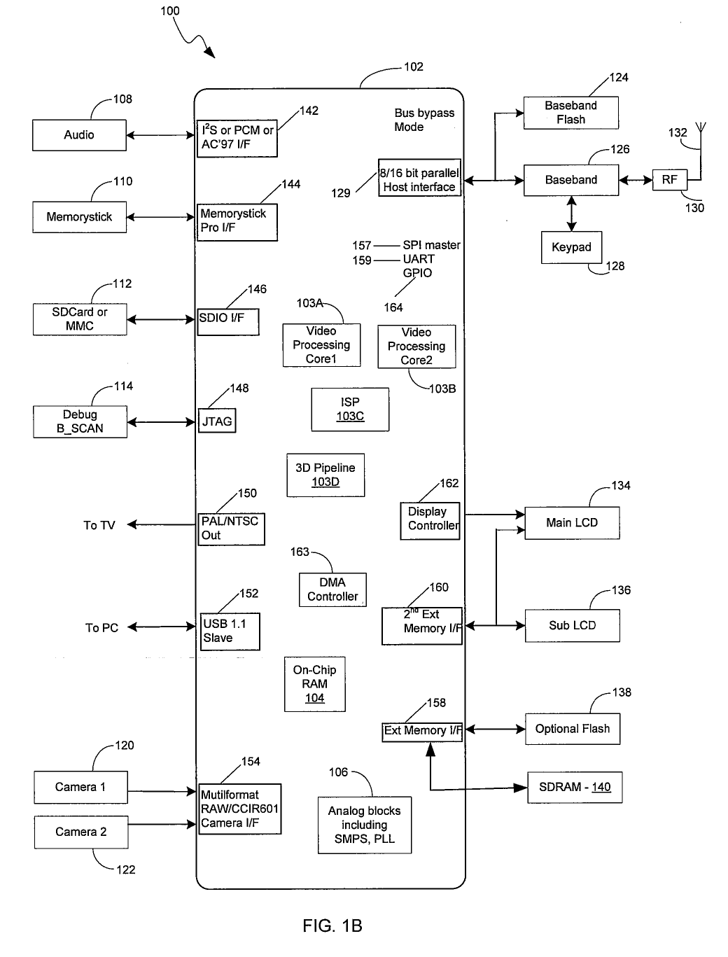

FIG. 1A is a block diagram of an exemplary mobile multimedia system, in accordance with an embodiment of the invention. Referring to FIG. 1A, there is shown a mobile multimedia system 105 that comprises a mobile multimedia device 105a, a TV 101h, a PC 101k, an external camera 101m, external memory 101n, and external LCD display 101p. The mobile multimedia device 105a may be a cellular telephone or other handheld communication device. The mobile multimedia device 105a may comprise a mobile multimedia processor (MMP) 101a, an antenna 101d, an audio block 101s, a radio frequency (RF) block 101e, a baseband processing block 101f, an LCD display 101b, a keypad 101c, and a camera 101g.

The MMP 101a may comprise suitable circuitry, logic, and/or code and may be adapted to perform video and/or multimedia processing for the mobile multimedia device 105a. The MMP 101a may further comprise a plurality of processor cores, indicated in FIG. 1A by Core 1 and Core2 as well as a hardware image sensor pipeline (ISP) 101x. The MMP 101a may also comprise integrated interfaces, which may be utilized to support one or more external devices coupled to the mobile multimedia device 105a. For example, the MMP 101a may support connections to a TV 101h, a PC 101k, an external camera 101m, external memory 101n, and an external LCD display 101p.

In operation, the mobile multimedia device may receive signals via the antenna 101d. Received signals may be processed by the RF block 101e and the RF signals may be converted to baseband by the baseband processing block 101f. Baseband signals may then be processed by the MMP 101a. Audio and/or video data may be received from the external camera 101m, and image data may be received via the integrated camera 101g. The image data may be forwarded to the ISP 101x for processing. The ISP 101x may perform a plurality of image data processing steps that may comprise distortion correction. In this regard, the ISP 101x may enable improvement in the quality of images displayed on the mobile multimedia system 105. During processing, the MMP 101a may utilize the external memory 101n for storing processed data. Image data may be processed in tile format, which may reduce the memory requirements for buffering of data during processing. Processed audio data may be communicated to the audio block 101s and processed video data may be communicated to the LCD 101b or the external LCD 101p, for example. The keypad 101c may be utilized for communicating processing commands and/or other data, which may be required for audio or video data processing by the MMP 101a.

FIG. 1B is a block diagram of an exemplary mobile multimedia processor, in accordance with an embodiment of the invention. Referring to FIG. 1B, the mobile multimedia processor 102 may comprise suitable logic, circuitry and/or code that may be adapted to perform video and/or multimedia processing for handheld multimedia products. For example, the mobile multimedia processor 102 may be designed and optimized for video record/playback, mobile TV and 3D mobile gaming, utilizing integrated peripherals and a video processing core. The mobile multimedia processor 102 may comprise video processing cores 103A and 103B, RAM 104, an analog block 106, a direct memory access (DMA) controller 163, an audio interface (I/F) 142, a memory stick I/F 144, SD card I/F 146, JTAG I/F 148, TV output I/F 150, USB I/F 152, a camera I/F 154, and a host I/F 129. The mobile multimedia processor 102 may further comprise a serial peripheral interface (SPI) 157, a universal asynchronous receiver/transmitter (UART) I/F 159, general purpose input/output (GPIO) pins 164, a display controller 162, an external memory I/F 158, and a second external memory I/F 160.

The video processing cores 103A and 103B may comprise suitable circuitry, logic, and/or code and may be adapted to perform video processing of data. The RAM 104 may comprise suitable logic, circuitry and/or code that may be adapted to store on-chip data such as video data. In an exemplary embodiment of the invention, the RAM 104 may be adapted to store 10 Mbits of on-chip data, for example. The size of the on-chip RAM 104 may vary depending on cost or other factors such as chip size.

The image sensor hardware pipeline (ISP) 103C may comprise suitable circuitry, logic and/or code that may enable the processing of image data. The ISP 103C may perform a plurality of processing techniques dark pixel compensation, lens shading correction, white balance and gain control, defective pixel correction, resampling, crosstalk correction, bayer denoising, demosaicing, gamma correction, YCbCr denoising, flase color suppression, sharpening, distortion correction, high resolution resize, color processing, color conversion, low resolution resize and output formatting for example. The ISP 103C may be communicatively coupled with the video processing cores 103A and/or 103B via the on-chip RAM 104 for distortion correction image processing. The processing of image data may be performed on variable sized tiles, reducing the memory requirements of the ISP 103C processes. In some embodiments of the invention, the image sensor hardware pipeline 103C may be capable of being tapped and any point and resulting tapped data may be communicated to a software process for handling. The resulting software processed data may then be reinserted back into the image sensor hardware pipeline 103C at any stage or point for continued processing. Data may be tapped from the image sensor hardware pipeline 103C at any point, communicated to a software process for processing, and reinserted back into any point of the ISP hardware pipeline 103C as may times as may be necessary for processing.

The analog block 106 may comprise a switch mode power supply (SMPS) block and a phase locked loop (PLL) block. In addition, the analog block 106 may comprise an on-chip SMPS controller, which may be adapted to generate its core voltage. The core voltage may be software programmable according to, for example, speed demands on the mobile multimedia processor 102, allowing further control of power management.

In an exemplary embodiment of the invention, the normal core operating range may be about 0.8 V-1.2 V and may be reduced to about 0.6 V during hibernate mode. The analog block 106 may also comprise a plurality of PLLs that may be adapted to generate about 195 kHz-200 MHz clocks, for example, for external devices. Other voltages and clock speeds may be utilized depending on the type of application. The mobile multimedia processor 102 may comprise a plurality of power modes of operation, for example, run, sleep, hibernate and power down. In accordance with an embodiment of the invention, the mobile multimedia processor 102 may comprise a bypass mode that may allow a host to access memory mapped peripherals in power down mode, for example. In bypass mode, the mobile multimedia processor 102 may be adapted to directly control the display during normal operation while giving a host the ability to maintain the display during standby mode.

The audio block 108 may comprise suitable logic, circuitry and/or code that may be adapted to communicate with the mobile multimedia processor 102 via an inter-IC sound (I²S), pulse code modulation (PCM) or audio codec (AC'97) interface 142 or other suitable interface, for example. In the case of an AC'97 and/or an I²S interface, suitable audio controller, processor and/or circuitry may be adapted to provide AC'97 and/or I²S audio output respectively, in either master or slave mode. In the case of the PCM interface, a suitable audio controller, processor and/or circuitry may be adapted to allow input and output of telephony or high quality stereo audio. The PCM audio controller, processor and/or circuitry may comprise independent transmit and receive first in first out (FIFO) buffers and may use DMA to further reduce processor overhead. The audio block 108 may also comprise an audio in, audio out port and a speaker/microphone port (not illustrated in FIG. 1B).

The mobile multimedia device 100 may comprise at least one portable memory input/output (I/O) block. In this regard, the memorystick block 110 may comprise suitable logic, circuitry and/or code that may be adapted to communicate with the mobile multimedia processor 102 via a memorystick pro interface 144, for example. The SD card block 112 may comprise suitable logic, circuitry and/or code that may be adapted to communicate with the mobile multimedia processor 102 via a SD input/output (I/O) interface 146, for example. A multimedia card (MMC) may also be utilized to communicate with the mobile multimedia processor 102 via the SD input/output (I/O) interface 146, for example. The mobile multimedia device 100 may comprise other portable memory I/O blocks such an xD I/O card.

The debug block 114 may comprise suitable logic, circuitry and/or code that may be adapted to communicate with the mobile multimedia processor 102 via a joint test action group (JTAG) interface 148, for example. The debug block 114 may be adapted to access the address space of the mobile multimedia processor 102 and may be adapted to perform boundary scan via an emulation interface. Other test access ports (TAPs) may be utilized. The phase alternate line (PAL)/national television standards committee (NTSC) TV output I/F 150 may be utilized for communication with a TV, and the universal serial bus (USB) 1.1, or other variant thereof, slave port I/F 152 may be utilized for communications with a PC, for example. The cameras 120 and/or 122 may comprise suitable logic, circuitry and/or code that may be adapted to communicate with the mobile multimedia processor 102 via a multiformat raw CCIR 601 camera interface 154, for example. The camera I/F 154 may utilize windowing and sub-sampling functions, for example, to connect the mobile multimedia processor 102 to a mobile TV front end.

The mobile multimedia processor 102 may also comprise a plurality of serial interfaces, such as the USB I/F 152, a serial peripheral interface (SPI) 157, and a universal asynchronous receiver/transmitter (UART) I/F 159 for Bluetooth or IrDA. The SPI master interface 157 may comprise suitable circuitry, logic, and/or code and may be utilized to control image sensors. Two chip selects may be provided, for example, to work in a polled mode with interrupts or via a DMA controller 163. Furthermore, the mobile multimedia processor 102 may comprise a plurality of general purpose I/O (GPIO) pins 164, which may be utilized for user defined I/O or to connect to the internal peripherals. The display controller 162 may comprise suitable circuitry, logic, and/or code and may be adapted to support multiple displays with XGA resolution, for example, and to handle 8/9/16/18/21-bit video data.

The baseband flash memory 124 may be adapted to receive data from the mobile multimedia processor 102 via an 8/16 bit parallel host interface 129, for example. The host interface 129 may be adapted to provide two channels with independent address and data registers through which a host processor may read and/or write directly to the memory space of the mobile multimedia processor 102. The baseband processing block 126 may comprise suitable logic, circuitry and/or code that may be adapted to convert RF signals to baseband and communicate the baseband processed signals to the mobile multimedia processor 102 via the host interface 129, for example. The RF processing block 130 may comprise suitable logic, circuitry and/or code that may be adapted to receive signals via the antenna 132 and to communicate RF signals to the baseband processing block 126. The host interface 129 may comprise a dual software channel with a power efficient bypass mode.

The main LCD 134 may be adapted to receive data from the mobile multimedia processor 102 via a display controller 162 and/or from a second external memory interface 160, for example. The display controller 162 may comprise suitable logic, circuitry and/or code and may be adapted to drive an internal TV out function or be connected to a range of LCD's. The display controller 162 may be adapted to support a range of screen buffer formats and may utilize direct memory access (DMA) to access the buffer directly and increase video processing efficiency of the video processing core 103. Both NTSC and PAL raster formats may be generated by the display controller 162 for driving the TV out. Other formats, for example SECAM, may also be supported.

In one embodiment of the invention, the display controller 162 may be adapted to support a plurality of displays, such as an interlaced display, for example a TV, and/or a non-interlaced display, such as an LCD. The display controller 162 may also recognize and communicate a display type to the DMA controller 163. In this regard, the DMA controller 163 may be fetch video data in an interlaced or non-interlaced fashion for communication to an interlaced or non-interlaced display coupled to the mobile multimedia processor 102 via the display controller 162.

The substitute LCD 136 may comprise suitable logic, circuitry and/or code that may be adapted to communicate with the mobile multimedia processor 102 via a second external memory interface, for example. The mobile multimedia processor 102 may comprise a RGB external data bus. The mobile multimedia processor 102 may be adapted to scale image output with pixel level interpolation and a configurable refresh rate.

The optional flash memory 138 may comprise suitable logic, circuitry and/or code that may be adapted to communicate with the mobile multimedia processor 102 via an external memory interface 158, for example. The optional SDRAM 140 may comprise suitable logic, circuitry and/or code that may be adapted to receive data from the mobile multimedia processor 102 via the external memory interface 158, for example. The external memory I/F 158 may be utilized by the mobile multimedia processor 102 to connect to external SDRAM 140, SRAM, Flash memory 138, and/or external peripherals, for example. Control and timing information for the SDRAM 140 and other asynchronous devices may be configurable by the mobile multimedia processor 102.

The mobile multimedia processor 102 may further comprise a secondary memory interface 160 to connect to connect to memory-mapped LCD and external peripherals, for example. The secondary memory interface 160 may comprise suitable circuitry, logic, and/or code and may be utilized to connect the mobile multimedia processor 102 to slower devices without compromising the speed of external memory access. The secondary memory interface 160 may provide 16 data lines, for example, 6 chip select/address lines, and programmable bus timing for setup, access and hold times, for example. The mobile multimedia processor 102 may be adapted to provide support for NAND/NOR Flash including NAND boot and high speed direct memory access (DMA), for example.

In operation, the mobile multimedia processor 102 may be adapted to perform a plurality of image processing tasks via a hardware image sensor pipeline (ISP). In some embodiments of the invention, image processing tasks may comprise dark pixel compensation, lens shading correction, white balance and gain control, defective pixel correction, re-sampling, crosstalk correction, bayer denoising, demosaicing, gamma correction, YCbCr denoising, flase color suppression, sharpening, distortion correction, high resolution resize, color processing, color conversion, low resolution resize and output formatting for example. In this regard, image data may be formatted in variable size tiles that may require fewer and smaller line buffers than conventional image processing. Furthermore, the ISP may begin processing tiles before the entire image is received. Between ISP hardware stages, a software distortion correction process may be inserted. Output from the distortion correction process may be returned to the ISP hardware for further processing and/or it may be stored for future or alternative use.

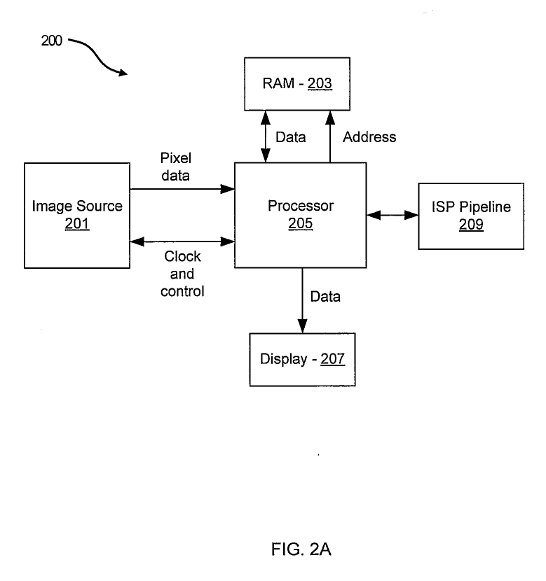

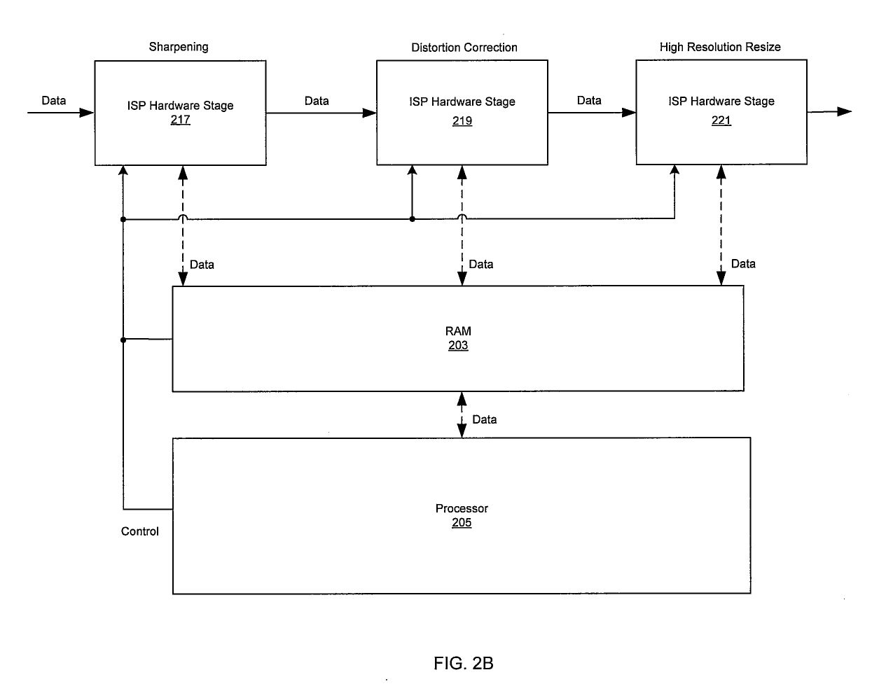

FIG. 2A is a block diagram of an exemplary mobile device configured to perform a plurality of image processing tasks comprising distortion correction, in accordance with an embodiment of the invention. Referring to FIG. 2A, there is shown an image processing system 200 comprising an image source 201, a RAM 203, a processing block 205, a display 207 and an image sensor pipeline (ISP) 209.

The image source 201 may comprise suitable circuitry, logic and or code to detect a visual image and convert light to an electrical signal representing the image. In this regard, the image source 201 may comprise, for example, a multi-mega pixel charged-coupled device (CCD) array, a complimentary metal oxide semiconductor (CMOS) array or another related technology. The image source 201 may be communicatively coupled with the RAM 203 and the processing block 205.

The processing block 205 may comprise suitable circuitry, logic and/or code that may be enabled to send control signals and/or receive image data from the image source 201, the RAM 203 and/or the ISP 209. The image data may be processed in variable size tiles. Moreover, the processing block 205 may be enabled to manage one or more image processing steps. In this regard, the processing block 205 may send control signals to the ISP 209 hardware. Moreover, the processing block 205 may insert software image processing steps before or after one or more ISP hardware processing stages within the ISP 209. The processing block 205 may also be enabled to communicate image data to the display 207.

The display 207 may comprise suitable circuitry, logic and/or code for displaying an image received from the image source 201 and the processing block 205.

The RAM 203 may comprise suitable circuitry, logic and/or code for storing data. The RAM 203 may be similar or substantially the same as the RAM 104 described in FIG. 1. The RAM 203 may be utilized to store image data as well as configuration data related to image processing. For example, characteristics of the image source 201 may be measured at the time of manufacture, and the distortion of the optics across a resulting image may be stored in the RAM 203.

The ISP 209 may comprise suitable circuitry, logic and/or code that may enable processing of image data received from the image source 201. A distortion correction processing task may be enabled by the ISP 209 hardware. Moreover, the ISP 209 may comprise suitable circuitry, logic and/or code allocated for a plurality of image processing tasks such as dark pixel compensation, lens shading correction, white balance and gain control, defective pixel correction, resampling, crosstalk correction, bayer denoising, demosaicing, gamma correction, YCbCr denoising, flase color suppression, sharpening, distortion correction, high resolution resize, color processing, color conversion, low resolution resize and output formatting for example. Various image processing steps may be performed by hardware in the ISP 209, and/or by software stored in the RAM 203 and executed by the processor 205. In this regard, image processing performed via software processes may be inserted before or after one or more of the ISP hardware image processing stages.

In operation, the processor 205 may receive image data in tiled format from the image source 201. The processor 205 may provide clock and control signals for synchronizing transfer of image data from the image source 201. Image processing may begin when a tile is received. The size of tiles may be determined by distortion in the image data that may be due to optical effects. Smaller sized tiles may be utilized in areas of the image where there may be higher distortion, such as around the edges, for example. The tile sizes may be determined by the distortion characteristics stored in the RAM 203. The image data may be passed to the ISP for various processing steps that may comprise dark pixel compensation, lens shading correction, white balance and gain control, defective pixel correction, resampling, crosstalk correction, bayer denoising, demosaicing, gamma correction, YCbCr denoising, flase color suppression, sharpening, distortion correction, high resolution resize, color processing, color conversion, low resolution resize and output formatting for example. In some embodiments of the invention, the output of one or more ISP hardware image processing steps may be stored in the RAM 203. The processor 205 may fetch the image data from the RAM 203 and may perform one or more image processing steps via software.

In an exemplary embodiment of the invention, the processor 205 may utilize software image processing to perform one or more image processing tasks. The output from the one or more software image processing tasks may be stored in RAM 203. The processor 205 may direct a subsequent hardware processing step within the ISP to fetch the output software processed image data from the RAM 203 and to continue image processing steps within the ISP 209 hardware. The processed image data may be stored in the RAM 203 prior to being communicated to the display 207. The processor 205 may communicate address data to the RAM 203 to determine where to read or write data in the RAM 203. Since the image data may be in tile format, the number and size of line buffers may be reduced in contrast to conventional systems which may process many entire rows of data from an image, generating large amounts of data to be stored in buffers. Output from various intermediate steps of image processing, either from the processing block 205 or from the ISP 209 may be stored for future use.

FIG. 2B is a block diagram of an exemplary image processing system comprising a portion of an image sensor pipeline (ISP) configured for distortion correction processing, in accordance with an embodiment of the invention. Referring to FIG. 2B, there is shown three ISP hardware processing stages 217, 219 and 221, a random access memory (RAM) 203, and a processor 205. The processor 205 and RAM 203 may be similar or substantially the same as the processor 205 and RAM 203 described in FIG. 2A.

The ISP hardware processing stages 217, 219 and 221 may each perform an image processing task that may comprise, for example, dark pixel compensation, lens shading correction, white balance and gain control, defective pixel correction, re-sampling, crosstalk correction, bayer denoising, demosaicing, gamma correction, YCbCr denoising, flase color suppression, sharpening, distortion correction, high resolution resize, color processing, color conversion, low resolution resize and/or output formatting for example. The ISP stages 217, 219 and 221 may be communicatively coupled with a previous hardware stage and a subsequent hardware stage as well as the RAM 203 and the processor 205.

In operation, the ISP 209 shown in FIG. 2A may comprise suitable circuitry, logic and/or code that may enable processing of image data received from the image source 201 shown in FIG. 2A. Image data may be processed via a plurality of steps or stages such as the ISP 209 hardware processing stages 217, 219 and/or 221. Moreover, image data may be processed in steps or stages by software stored in the RAM 203 and executed by the processor 205. Accordingly, Image data may be organized into a tile format wherein data for an image may be divided into variable size portions or tiles and processed on a per tile basis. Once an image data tile has entered the ISP 209 pipeline, an ISP 209 hardware processing stage may retrieve data from a previous ISP 209 hardware stage, may process the retrieved image data and may output the processed image data. In this regard, different stages of the ISP 209 may process different tiles of image data concurrently. Moreover, one or more software image processing stages may be inserted between ISP hardware processing stages. In this regard, the ISP stages 217, 219 and 221 may be configured to receive control signals from the processor 205 and to send and receive image data to and from the RAM 203. The processor 205 may be enabled to perform any of the image processing steps via software. Accordingly, image data processing comprising distortion correction may be performed within hardware on the ISP 209 and/or by software programmed on the processor 205.

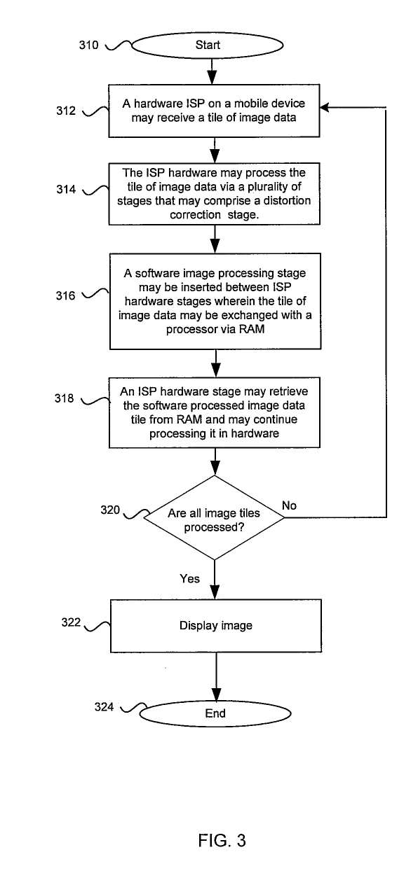

FIG. 3 is a flow chart illustrating exemplary steps for an image sensor pipeline on a mobile imaging device enabled for distortion correction, in accordance with an embodiment of the invention. Referring to FIG. 3, after start step 310, in step 312 the ISP 209 may receive a tile of image data from the image source 201. In step 314, the ISP 209 may process the tile of image data via a plurality of image processing stages that may comprise a distortion correction stage. In step 316, one or more software image processing stages may be inserted between ISP hardware stages wherein the tile of image data may be written to RAM 203, read by the processor 205 and processed. The processed tile output from software image data processing may be sent to RAM 203. In step 318, a subsequent ISP 209 hardware stage may retrieve the processed tile output from the software image data processing from RAM 203 and may continue processing the image data tile. In step 320, if all of the tiles comprised in an image are processed, the procedure may proceed to step 322. In step 322, the image may be displayed on the display 207. The step 324 is the end step. In step 320, if not all of the tiles comprised in the image are processed, the procedure may proceed to step 312.

In an embodiment of the invention, images are processed within a mobile device as described in FIGS. 1A, 1B, 2A and 2B. In this regard, the image data may be divided into variable size tiles and processed on a per tile basis within an image sensor pipeline 209 (ISP) via one or more of a plurality of steps and/or processes. The processing one or more of a plurality of steps and/or processes may comprise one or more distortion correction steps. A portion of the plurality of variable size tiles may be processed via software processing on the processor 205. As such, output from any portion of the ISP 209 may be stored in RAM 203 and subsequently retrieved for processing via one or more software processes. The results from software processing may be stored in RAM 203 and communicated to any portion of the hardware ISP for additional processing. Accordingly, a portion of the plurality of variable size tiles may be processed via the hardware ISP 209 while simultaneously a second portion of the plurality of variable size tiles may be processed via software and the processor 205 for example.

Certain embodiments of the invention may comprise a machine-readable storage having stored thereon, a computer program having at least one code section for an image sensor pipeline on a mobile imaging device, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for processing images, the method comprising:
dividing raw image data into a plurality of variable size tiles; and
processing each of said plurality of variable size tiles on a tile-by-tile basis via one or more of a plurality of steps and/or processes comprising distortion correction within a hardware image sensor pipeline (ISP) on a mobile device.

2. The method according to claim 1, comprising determining a size for one or more of said plurality of variable size tiles based on distortion within a corresponding local region of said raw image data.

3. The method according to claim 2, comprising processing a portion of said plurality of variable size tiles via software processing in a processor.

4. The method according to claim 3, comprising storing output from any portion of said image hardware sensor pipeline.

5. The method according to claim 4, comprising retrieving and processing said stored output via one or more software processes.

6. The method according to claim 5, comprising storing results from said processing via said one or more software processes.

7. The method according to claim 6, comprising communicating said stored results from said processing via said one or more software processes to any portion of said image hardware sensor pipeline for processing.

8. The method according to claim 7, comprising simultaneously processing a first portion of said plurality of said variable size tiles via a image sensor hardware pipeline and a second portion of said plurality of said variable size tiles via one or more software processes or steps.

9. A system for processing images, the system comprising:
one or more circuits that enable:
dividing raw image data into a plurality of variable size tiles; and
processing each of said plurality of variable size tiles on a tile-by-tile basis via one or more of a plurality of steps and/or processes comprising distortion correction within a hardware image sensor pipeline (ISP) on a mobile device.

10. The system according to claim 9, wherein said one or more circuits enables determination of a size for one or more of said plurality of variable size tiles based on distortion within a corresponding local region of said raw image data.

11. The system according to claim 10, wherein said one or more circuits enables processing of a portion of said plurality of variable size tiles via software processing in a processor.

12. The system according to claim 11, wherein said one or more circuits enables storage of output from any portion of said image hardware sensor pipeline.

13. The system according to claim 12, wherein said one or more circuits enables retrieval and processing of said stored output via one or more software processes.

14. The system according to Claim 13, wherein said one or more circuits enables storage of results from said processing via said one or more software processes.

15. The system according to claim 14, wherein said one or more circuits enables communication of said stored results from said processing via said one or more software processes to any portion of said image hardware sensor pipeline for processing.

16. The system according to claim 15, wherein said one or more circuits enables simultaneous processing of a first portion of said plurality of said variable size tiles via a image sensor hardware pipeline and a second portion of said plurality of said variable size tiles via one or more software processes or steps.

17. A machine-readable storage having stored thereon, a computer program having at least one code section for processing images, the at least one code section being executable by a machine for causing the machine to perform steps comprising:
dividing raw image data into a plurality of variable size tiles; and
processing each of said plurality of variable size tiles on a tile-by-tile basis via one or more of a plurality of steps and/or processes comprising distortion correction within a hardware image sensor pipeline (ISP) on a mobile device.

18. The machine-readable storage according to claim 17, wherein said at least one code section comprises code that enables determining a size for one or more of said plurality of variable size tiles based on distortion within a corresponding local region of said raw image data.

19. The machine-readable storage according to claim 18, wherein said at least one code section comprises code that enables processing a portion of said plurality of variable size tiles via software processing in a processor.

20. The machine-readable storage according to claim 19, wherein said at least one code section comprises code that enables storing output from any portion of said image hardware sensor pipeline.

21. The machine-readable storage according to claim 20, wherein said at least one code section comprises retrieving and processing said stored output via one or more software processes.

22. The machine-readable storage according to claim 21, wherein said at least one code section comprises code that enables storing results from said processing via said one or more software processes.

23. The machine-readable storage according to claim 22, wherein said at least one code section comprises code that enables communicating said stored results from said processing via said one or more software processes to any portion of said image hardware sensor pipeline for processing.

24. The machine-readable storage according to claim 23, wherein said at least one code section comprises code that enables simultaneously processing a first portion of said plurality of said variable size tiles via a image sensor hardware pipeline and a second portion of said plurality of said variable size tiles via one or more software processes or steps.
